(19) United States
(12) Patent Application Publication
(10) Pub. No.: US 2026/0341077 A1
(43) Pub. Date: Oct. 29, 2026

(54) METHOD, DEVICE AND STORAGE MEDIUM FOR IMAGE PROCESSING

(71) Applicant: Beijing Zitiao Network Technology Co., Ltd., Beijing (CN)

(72) Inventors: Yijie XIE, Beijing (CN); Xubin ZHOU, Beijing (CN)

(21) Appl. No.: 19/104,069

(22) PCT Filed: Aug. 16, 2023
(86) PCT No.: PCT/CN2023/113234

§ 371 Date: Feb. 14, 2025

(30) Foreign Application Priority Data
Aug. 17, 2022 (CN) 202210988925.6

(51) Int. Cl. G06V 40/16; G06V 10/26

(52) U.S. Cl. CPC G06V 40/171; G06V 10/26; G06V 40/161

(57) ABSTRACT

Embodiments of the present disclosure provide an image processing method and apparatus, a device, and a storage medium. The method includes: identifying a target object in an original image to obtain a target object image and a splitting line of the target object, wherein the target object image is split by the splitting line, with an image on one side of the splitting line referred to as a first-side image, and an image on the other side of the splitting line referred to as a second-side image; replacing a pixel value of the first-side image with a preset pixel value; and performing, based on the splitting line, mirror processing on the second-side image to obtain a first-side mirror image, wherein the first-side mirror image and the second-side image are mirror images of each other.

### CROSS-REFERENCE TO RELATED APPLICATION(S)

The present disclosure claims the priority from the Chinese patent application No. 202210988925.6 filed with the China National Intellectual Property Administration (CNIPA) on Aug. 17, 2022, the disclosure of which is hereby incorporated by reference in its entirety.

### FIELD

The present disclosure relates to the technical field of image processing technology, for example, to an image processing method and apparatus, a device and a storage medium.

### BACKGROUND

Image processing applications (APPs) are developing rapidly, filling users' life with more color. A user can record his/her life through videos, photos and the like, and process images with effect technologies provided by an image processing APP, to make the images more diversified through beautification, stylization, expression editing and the like.

### SUMMARY

Embodiments of the present disclosure provide an image processing method and apparatus, a device and a storage medium, where images with a mirror effect can be generated to enrich display contents of the images and make the images more entertaining.

In a first aspect, the embodiments of the present disclosure provide an image processing method, comprising: identifying a target object in an original image to obtain a target object image and a splitting line of the target object, wherein the target object image is split by the splitting line into a first-side image and a second-side image; replacing a pixel value of the first-side image with a preset pixel value; and performing, based on the splitting line, mirror processing on the second-side image to obtain a first-side mirror image, wherein the first-side mirror image and the second-side image are mirror images of each other.

In a second aspect, the embodiments of the present disclosure provide an image processing apparatus, comprising: a target object identification module configured to identify a target object in an original image to obtain a target object image and a splitting line of the target object, wherein the target object image is split by the splitting line into a first-side image and a second-side image; a pixel value replacement module configured to replace a pixel value of the first-side image with a preset pixel value; and a mirror processing module configured to perform, based on the splitting line, mirror processing on the second-side image to obtain a first-side mirror image, wherein the first-side mirror image and the second-side image are mirror images of each other.

In a third aspect, the embodiments of the present disclosure provide an electronic device, comprising: one or more processors; and a memory configured to store one or more programs; wherein the one or more programs, when executed by the one or more processors, cause the one or more processors to implement the image processing method according to the embodiments of the present disclosure.

In a fourth aspect, embodiments of the present disclosure further provide a storage medium comprising computer executable instructions which implement the image processing method according to the embodiments of the present disclosure when executed by a computer processor.

### BRIEF DESCRIPTION OF THE DRAWINGS

Throughout the drawings, the same or similar reference symbols represent the same or similar components. It would be appreciated that the drawings are provided illustratively, where the components and elements are not necessarily drawn to scale.

FIG. 1 illustrates a flowchart of an image processing method according to some embodiments of the present disclosure;

FIG. 2 illustrates a schematic diagram of determining a splitting line of a target object according to some embodiments of the present disclosure;

FIG. 3a illustrates a schematic diagram of a mirrored target object according to some embodiments of the present disclosure;

FIG. 3b illustrates a schematic diagram of a further mirrored target object according to some embodiments of the present disclosure;

FIG. 4 illustrates a schematic diagram of a structure of an image processing apparatus according to some embodiments of the present disclosure; and

FIG. 5 illustrates a schematic diagram of a structure of an electronic device according to some embodiments of the present disclosure.

### DETAILED DESCRIPTION OF EMBODIMENTS

Reference now will be made to the drawings to describe the embodiments of the present disclosure. It would be appreciated by those skilled in the art that the drawings and embodiments of the present disclosure are provided exemplarily, without suggesting any limitation to the protection scope of the present disclosure.

It is to be understood that respective steps in the implementations of the methods according to the present disclosure may be performed in different orders and/or performed in parallel. In addition, the method implementations may include additional steps and/or steps omitted. The scope of the present disclosure is not limited in the aspect.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second” and the like mentioned in the present disclosure are only used to distinguish different apparatuses, modules or units, rather than limit an order of functions performed by the apparatus, module or unit or limit interdependence.

It should be noted that, the terms “a”, “an”, and “a plurality of” mentioned in the present disclosure are illustrative, not restrictive, and should be understood as “one or more” by those skilled in the art, unless explicitly specified otherwise in the context.

Names of messages or information interacted between a plurality of apparatuses in the embodiments of the present disclosure are illustrative rather than limit the scope of the messages or information.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

The data (including data per se, and acquisition or application of the data) involved in the present technical solution should comply with the provisions of the corresponding laws and regulations as well as relevant stipulations.

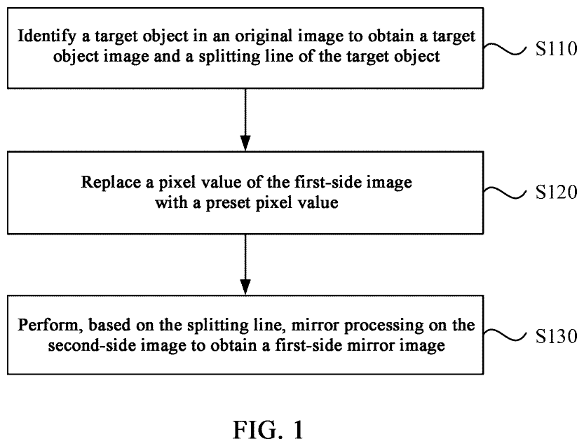

FIG. 1 is a flowchart of an image processing method according to some embodiments of the present disclosure. The embodiments of the present disclosure can be applied to a scenario of performing mirror processing for a target object in an image. The method can be performed by an image processing apparatus, which can be implemented in the form of software and/or hardware, or by an electronic device that may be a mobile terminal, a Personal Computer (PC) or a server, or the like.

As shown therein, the method includes:

S110: identify a target object in an original image to obtain a target object image and a splitting line of the target object.

The target object image is split by the splitting line, with an image on one side of the splitting line referred to as a first-side image, and an image on the other side of the splitting line referred to as a second-side image. The target object may be any object such as a portrait, an animal, a building and the like. The target object image may be regarded as an image obtained by subtracting a target image from an original image. The splitting line of the target object may be a central axis of the target object, which acts as a line of symmetry in the subsequent mirror processing.

In the embodiments, identifying the target object in the original image to obtain the target object image may include: identifying the target object in the original image to obtain a mask image of the target object; and fusing the mask image of the target object and the original image to obtain the target object image.

A pixel value of each pixel point in the mask image of the target object characterizes a confidence that the pixel point belongs to the target object, which may be any value between 0-1, where 1 is white, and 0 is black. The pixel value can be stored in a preset color channel in the mask image of the target object, for example, a red (R) channel, a green (G) channel or a blue (B) channel. Identifying the target object in the original image to obtain the mask image of the target object may be implemented as follows: inputting the original image into a target object identification model to identify whether each pixel point in the original image belongs to the target object, and obtaining a confidence that each pixel point belongs to the target object, to thus obtain the mask image of the target object. Fusing the mask image of the target object and the original image may be implemented as follows: multiplying a pixel value of the mask image of the target object with a color value of the original image (values of the four RGBA channels), to obtain the target object image. By obtaining the target object image based on the mask image of the target object, these embodiments can improve the accuracy of extracting the target object from the original image.

Optionally, identifying the target object in the original image to obtain the splitting line of the target object may include: determining two key points of the target object in the original image; and determining a line connecting the two key points as the splitting line of the target object.

The key points may be two points located on a central axis of the target object. Determining two key points of the target object in the original image may be implemented as follows: inputting the original image into a central-axis determining module to output coordinate information of the two key points. Determining a line connecting the two key points as the splitting line of the target object may be implemented as follows: determining an equation of the splitting line based on the coordinate information of the two key points. By way of an example, assuming that coordinate information of one of the two key points is (x1, y1) while coordinate information of the other one is (x2, y2), the equation of the splitting line may be provided as: (x−x1)/(x2−x1)=(y−y1)/(y2−y1). By determining the splitting line based on the two key points, these embodiments can reduce the computing amount while improving the computing efficiency.

Optionally, if the target object is a portrait that includes a face and/or a body, determining the two key points of the target object in the original image may include: determining a glabella key point and a chin key point in the face of the portrait in the original image; and determining the line connecting the two key points as the splitting line of the target object may include: determining a line connecting the glabella key point and the chin key point as the splitting line of the portrait.

The 68 facial key point (landmark) detection method may be performed on the face of the portrait; then, the glabella key point (the 49th key point) and the chin key point (the 16th key point) are extracted from 68 facial key points; and finally, a line connecting the glabella key point and the chin key point is determined as the splitting line of the portrait. By determining the splitting line of the portrait based on the glabella key point and the chin key point, these embodiments can improve the accuracy of determining the splitting line of the portrait.

Optionally, identifying the target object in the original image to obtain the splitting line of the target object may include: determining a detection box of the target object in the original image; and determining, based on a central axis of the detection box, the splitting line of the target object.

Determining the detection box of the target object in the original image may be implemented as follows: inputting the original image into a target detection model to output a detection box of the target object. Determining, based on the central axis of the detection box, the splitting line of the target object may be implemented as follows: obtaining a horizontal or vertical central axis of the detection box; then, obtaining pose information of the target object in the original image; rotating, based on the pose information of the target object, the horizontal or vertical central axis; and determining the rotated horizontal or vertical central axis as the splitting line of the target object.

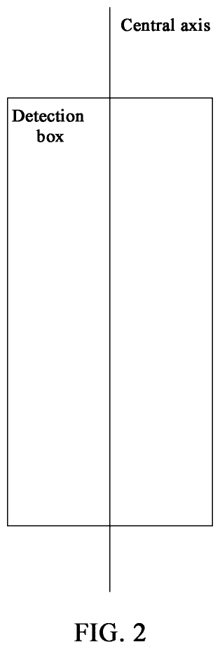

FIG. 2 illustrates a schematic diagram of determining the splitting line of the target object according to the embodiments. As shown therein, the splitting line of the target object is determined based on the vertical central axis of the detection box. By determining, based on the central axis of the detection box, the splitting line of the target object, these embodiments can improve the efficiency of determining the splitting line.

S120: replace a pixel value of the first-side image with a preset pixel value.

The first-side image may be an image on either side of the splitting line. For example, assumed that the splitting line is a vertical splitting line, the first-side image may be a right or a left image with respect to the splitting line; assumed that the splitting line is a horizontal splitting line, the first-side image may be an upper or a lower image with respect to the splitting line. The preset pixel value may be a pixel value set arbitrarily by a user, or may be a pixel value selected from a background area of the original image.

In these embodiments, replacing the pixel value of the first-side image with the preset pixel value may include: extracting the pixel value belonging to the first-side image from the target object image; then replacing the pixel value of the pixel point belonging to the first-side image with the preset pixel value.

Optionally, replacing the pixel value of the first-side image with the preset pixel value may include: traversing pixel points of the target object image, and inputting coordinate information of each traversed pixel point to an equation of the splitting line to obtain a result value of the coordinate information of each traversed pixel point; if the result value of the coordinate information of each traversed pixel point is greater than a preset value, replacing a pixel value of each traversed pixel point with the preset pixel value.

The equation of the splitting line may be read as a functional expression of the splitting line. The equation may be a two-variable linear equation expressed as f(x, y)=a*x+b*y+c, where a, b and c are constants. The preset value may be 0. Inputting coordinate information of the traversed pixel point to the equation of the splitting line may be read as substituting the coordination information of the traversed pixel point into the equation of the splitting line. If the result value is greater than 0, the traversed pixel point belongs to the first-side image; if the result value is equal to 0, the pixel point is located on the splitting line; if the result value is less than 0, the pixel point belongs to the second-side image. By way of an example, assuming that the coordinate information of the traversed pixel point is (x0, y0), the result value is f(x0, y0)=a*x0+b*y0+c; if f(x0, y0)>0, the traversed pixel point belongs to the first-side image, and the pixel value of the traversed pixel point is replaced with the preset pixel value.

Optionally, replacing the pixel value of the first-side image with the preset pixel value may include: traversing pixel points of the target object image, and inputting coordinate information of each traversed pixel point to the equation of the splitting line to obtain a result value; if the result value of the coordinate information of each traversed pixel point is less than a preset value, replacing a pixel value of each traversed pixel point with the preset pixel value.

The equation of the splitting line may be read as a functional expression of the splitting line. The equation may be a two-variable linear equation expressed as f(x, y)=a*x+b*y+c, where a, b and c are constants. The preset value may be 0. Inputting coordinate information of the traversed pixel point to the equation of the splitting line may be read as substituting the coordination information of the traversed pixel point into the function of the splitting line. If the result value is less than 0, the traversed pixel point belongs to the first-side image; if the result value is equal to 0, the pixel point is located on the splitting line; if the result value is greater than 0, the pixel point belongs to the second-side image. By way of example, assumed that the coordinate information of the traversed pixel point is (x0, y0), the result value is f(x0, y0)=a*x0+b*y0+c; if f(x0, y0)<0, the traversed pixel point belongs to the first-side image, and the pixel value of the traversed pixel point is replaced with the preset pixel value. By determining, based on the result value obtained by inputting the coordinate information of the traversed pixel point into the equation of the splitting line, whether the pixel point belongs to the first-side image, these embodiments can improve the accuracy of replacing the pixel value.

Optionally, replacing the pixel value of the first-side image with the preset pixel value may include: selecting a pixel value from a background area of the original image as the preset pixel value; and replacing the pixel value of the first-side image with the preset pixel value.

Selecting the pixel value from the background area of the original image as the preset pixel value may be implemented as: arbitrarily selecting a pixel point from the background area, and setting the pixel value of the pixel point as the preset pixel value; or calculating an average of pixel values of pixel points in the background area, and setting the average pixel value as the preset pixel value; or selecting a pixel point located on an edge of the target object and within the background area, and using a pixel value of the pixel point as the preset pixel value; or calculating an average of pixel values of pixel points located on an edge of the target object and within the background area, and using the average pixel value as the preset pixel value. By replacing the pixel value of the first-side image with a pixel value selected from the background area of the original image, these embodiments can achieve a smooth transition between the first-side mirror image generated subsequently and the background area, thus improving the display effect of the mirrored target object.

Optionally, after replacing the pixel value of the first-side image with the preset pixel value, the method further includes: blurring the first-side image including the replaced pixel value.

The blurring may be Gaussian blurring. In some embodiments, blurring the first-side image including the replaced pixel value may be implemented as: performing multiple Gaussian blurring operations on the first-side image including the replaced pixel value to obtain the blurred first-side image. By blurring the first-side image including the replaced pixel value, these embodiments can conceal the first-side image, to prevent the impact of the first-side image on the display effect of the first-side mirror image.

S130: Perform, based on the splitting line, mirror processing on the second-side image to obtain a first-side mirror image.

The first-side mirror image and the second-side image are mirror images of each other, i.e., the second-side image and the first-side mirror image are symmetrical with respect to the splitting line.

In these embodiments, performing, based on the splitting line, mirror processing on the second-side image may include: for each pixel point in the second-side image, determining a pixel point symmetrical thereto with respect to the splitting line; then using the pixel value of the pixel point of the second-side image as the pixel value of the pixel point symmetrical thereto; rendering, based on the determined pixel value, the first-side image to obtain the first-side mirror image.

Optionally, performing, based on the splitting line, mirror processing on the second-side image to obtain a first-side mirror image may include: for a pixel point of the second-side image, determining a pixel point of the first-side image symmetrical to the pixel point of the second-side image with respect to the splitting line; determining the pixel value of the pixel point of the second-side image as a target pixel value of the pixel point of the first-side image; rendering, based on the target pixel value, the first-side image to obtain the first-side mirror image.

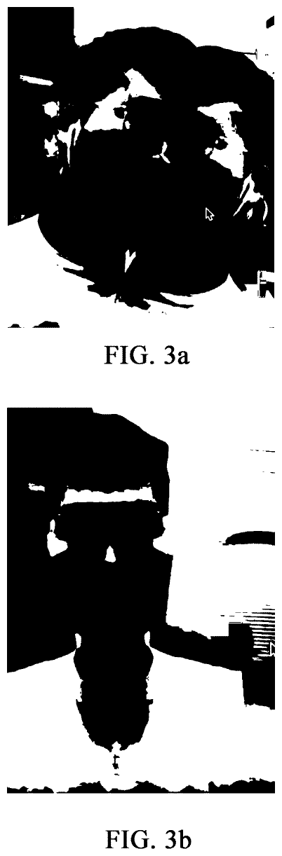

Determining the pixel point of the first-side image symmetrical to the pixel point of the second-side image with respect to the splitting line may be implemented as follows: obtaining coordination information of the pixel point of the second-side image and the function of the splitting line, and determining, according to the symmetry principle, coordination information of the pixel point of the first-side image symmetrical to the pixel point of the second-side image with respect to the splitting line. The specific implementation of the symmetry principle is omitted herein for brevity. By way of example, FIGS. 3a-3b are schematic diagrams of a generated mirrored target object according to these embodiments. As shown therein, the target object is a portrait, where a generated first-side mirror image is on the left side, and the original portrait is on the left side. By performing, based on the splitting line, mirror processing on the second-side image, these embodiments can improve the accuracy of obtaining the mirror image.

Optionally, before performing, based on the splitting line, the mirror processing on the second-side image, the method further includes: obtaining a screen aspect ratio; and adjusting, based on the screen aspect ratio, the splitting line; and performing, based on the splitting line, the mirror processing on the second-side image includes: performing, based on the adjusted splitting line, the mirror processing on the second-side image.

The screen aspect ratio may be read as a ratio between a height and a width of a current screen of a terminal device, which may be 16:9, 4:3 or the like, for example. In some embodiments, adjusting, based on the screen aspect ratio, the splitting line may be: adjusting, based on the screen aspect ratio, a slope of the splitting line. Assuming that the slope of the splitting line is k and the screen aspect ratio is 16:9, the adjusted slope is k*16/9. Optionally, adjusting, based on the screen aspect ratio, the splitting line may be: adjusting, based on the screen aspect ratio, coordinates of two points on the splitting line, and generating, based on the two points with the adjusted coordinates, a new splitting line. By way of an example, assuming that the coordinates of the two points on the splitting line are A (x1, y1) and B (x2, y2), respectively, the screen aspect ratio is 16:9, and the adjusted coordinates of the two points are A1 (x1, y1*16/9) and B1 (x2, y2*16/9); finally, the line connecting A and B1 is the adjusted splitting line. By adjusting the splitting line based on the screen aspect ratio, these embodiments can prevent the mirrored target object from being stretched when displayed on the current screen.

The technical solutions according to embodiments of the present disclosure may include: identifying a target object in an original image to obtain a target object image and a splitting line of the target object, wherein the target object image is split by the splitting line into a first-side image and a second-side image; replacing a pixel value of the first-side image with a preset pixel value; and performing, based on the splitting line, mirror processing on the second-side image to obtain a first-side mirror image, wherein the first-side mirror image and the second-side image are mirror images of each other. With the image processing method provided by the embodiments of the present disclosure, including performing, based on a splitting line of a target object, mirror processing on a target object on a side of the splitting line to obtain a mirror image of the target image, an image with a mirror special effect can be generated, which makes the display content of the image more diversified.

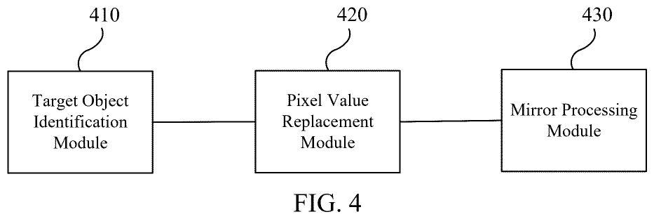

FIG. 4 illustrates a schematic diagram of a structure of an image processing apparatus according to some embodiments of the present disclosure. As shown therein, the apparatus includes: a target object identification module 410 configured to identify a target object in an original image to obtain a target object image and a splitting line of the target object, wherein the target object image is split by the splitting line into a first-side image and a second-side image; a pixel value replacement module 420 configured to replace a pixel value of the first-side image with a preset pixel value; and mirror processing module 430 configured to perform, based on the splitting line, mirror processing on the second-side image to obtain a first-side mirror image, wherein the first-side mirror image and the second-side image are mirror images of each other.

Optionally, the target object identification module 410 is configured to identify the target object in the original image to obtain the target object image in such manner of: identifying the target object in the original image to obtain a mask image of the target object; and fusing the mask image of the target object and the original image to obtain the target object image.

Optionally, the target object identification module 410 is configured to identify the target object in the original image to obtain the splitting line of the target object in such manner of: determining two key points of the target object in the original image; and determining a line connecting the two key points as the splitting line of the target object.

Optionally, if the target object is a portrait comprising of a face and/or a body, the target object identification module 410 is configured to determine two key points of the target object in the original image in such manner of: determining a glabella key point and a chin key point in the face of the portrait in the original image; and the target object identification module 410 is configured to determine the line connecting the two key points as the splitting line of the target object in such manner of: determining a line connecting the glabella key point and the chin key point as the splitting line of the portrait.

Optionally, the target object identification module 410 is configured to identify the target object in the original image to obtain the splitting line of the target object in such manner of: determining a detection box of the target object in the original image; and determining, based on a central axis of the detection box, the splitting line of the target object.

Optionally, the pixel value replacement module 420 is configured to: traverse pixel points of the target object image, and input coordinate information of each traversed pixel point to an equation of the splitting line to obtain a result value of the coordinate information of each traversed pixel point; in a case that the result value of the coordinate information of each traversed pixel point is greater than a preset value, replace a pixel value of each traversed pixel point with the preset pixel value; or in a case that the result value of the coordinate information of each traversed pixel point is less than a preset value, replace a pixel value of each traversed pixel point with the preset pixel value.

Optionally, the pixel value replacement module 420 is configured to: select a pixel value from a background area of the original image as the preset pixel value; and replace the pixel value of the first-side image with the preset pixel value.

Optionally, the apparatus further includes: a blurring module configured to: blur the first-side image including the replaced pixel value.

Optionally, the mirror processing module 430 is configured to: for a pixel point of the second-side image, determine a pixel point of the first-side image symmetrical to the pixel point of the second-side image with respect to the splitting line; determine a pixel value of the pixel point of the second-side image as a target pixel value of the pixel point of the first-side image; and render, based on the target pixel value, the first-side image to obtain the first-side mirror image.

Optionally, the apparatus further includes: an adjustment module configured to obtain a screen aspect ratio; and adjusting, based on the screen aspect ratio, the splitting line; and alternatively, the mirror processing module 430 is configured to perform, based on the adjusted splitting line, the mirror processing on the second-side image.

The image processing apparatus according to the embodiments of the present disclosure can perform the image processing method provided by any of the embodiments of the present disclosure, which includes functional modules corresponding to the method and can achieve the corresponding effects.

The units or modules included in the above-mentioned apparatus may be divided according to the functional logic, which are not limited to the above division as long as they can implement the respective functions. In addition, names of the units or modules are used only for differentiation from one another, without suggesting any limitation to the protection scope of the embodiments of the present disclosure.

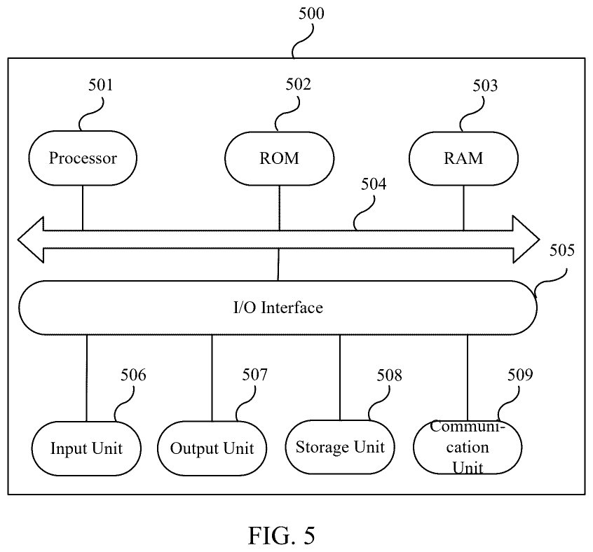

FIG. 5 illustrates a schematic diagram of a structure of an electronic device according to some embodiments of the present disclosure. Hereinafter, reference will be made to FIG. 5 that illustrates a schematic diagram of a structure of an electronic device (e.g. a terminal device or server in FIG. 5) 500 adapted to implement embodiments of the present disclosure. The terminal device according to the embodiments of the present disclosure may include a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital television (TV), a desktop computer or the like. The electronic device 500 as shown in FIG. 5 is provided merely as an example, without suggesting any limitation to the functions and the application range of the embodiments of the present disclosure.

As shown therein, the electronic device 500 may include a processor (e.g. a central processor, a graphics processor or the like) 501, which can execute various acts and processing based on programs stored in a Read Only Memory (ROM) 502 or a program loaded from a storage unit 508 to a Random Access Memory (RAM) 503. RAM 503 stores therein various programs and data required for operations of the electronic device 500. The processor 501, the ROM 502 and the RAM 503 are connected to one another via a bus 504. An input/output (I/O) interface 505 is also connected to the bus 504.

Typically, the following units may be connected to the I/O interface 505: an input unit 506 including, for example, a touchscreen, a touch pad, a keyboard, a mouse, a camera, a microphone, an accelerometer, a gyroscope and the like; an output unit 507 including, for example, a Liquid Crystal Display (LCD), a loudspeaker, a vibrator and the like; a storage unit 508 including, for example, a tape, a hard drive and the like; and a communication unit 509. The communication unit 509 can allow wireless or wired communication of the electronic device 500 with other devices to exchange data. Although FIG. 5 shows the electronic device 500 including various units, it would be appreciated that not all of the units as shown are required to be implemented or provided. Alternatively, more or fewer units may be implemented or provided.

In particular, according to embodiments of the present disclosure, the processes described above with reference to the flowchart may be implemented as a computer software program. For example, embodiments of the present disclosure include a computer program product comprising computer programs carried on a non-transitory computer readable medium, the computer program containing program code for performing the method as shown in the flowchart. In those embodiments, the computer program may be downloaded and installed from a network via the communication unit 509, or may be installed from the storage unit 508, or may be installed from the ROM 502. The computer program, when executed by the processor 501, performs the above-described functions defined in the method according to the embodiments of the present disclosure.

Names of messages or information interacted between a plurality of apparatuses in the embodiments of the present disclosure are illustrative rather than limit the scope of the messages or information.

The electronic device provided by the embodiments of the present disclosure belongs to the same invention conception as the image processing method provided by the above-mentioned embodiments. For the technical details not exhausted here, see the above-mentioned embodiments, and these embodiments can achieve the same advantageous effect as the above-mentioned embodiments.

The embodiments of the present disclosure provide a computer storage medium having a computer program stored thereon, where the program, when executed by a processor, implements the image processing method provided by the above-mentioned embodiments.

The computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to: identify a target object in an original image to obtain a target object image and a splitting line of the target object, wherein the target object image is split by the splitting line, with an image on one side of the splitting line referred to as a first-side image, and an image on the other side of the splitting line referred to as a second-side image; replace a pixel value of the first-side image with a preset pixel value; and perform, based on the splitting line, mirror processing on the second-side image to obtain a first-side mirror image, wherein the first-side mirror image and the second-side image are mirror images of each other.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/modules do not formulate limitation to the units per se. For example, the target object identification module may also be described as “a module for identifying a target object in an original image to obtain a target object image and a splitting line of the target object.”

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

According to one or more embodiments of the present disclosure, there is provided an image processing method, comprising: identifying a target object in an original image to obtain a target object image and a splitting line of the target object, wherein the target object image is split by the splitting line, with an image on one side of the splitting line referred to as a first-side image, and an image on the other side of the splitting line referred to as a second-side image; replacing a pixel value of the first-side image with a preset pixel value; and performing, based on the splitting line, mirror processing on the second-side image to obtain a first-side mirror image, wherein the first-side mirror image and the second-side image are mirror images of each other.

Optionally, identifying the target object in the original image to obtain the target object image comprises: identifying the target object in the original image to obtain a mask image of the target object; and fusing the mask image of the target object and the original image to obtain the target object image.

Optionally, identifying the target object in the original image to obtain the splitting line of the target object comprises: determining two key points of the target object in the original image; and determining a line connecting the two key points as the splitting line of the target object.

Optionally, if the target object is a portrait, determining the two key points of the target object in the original image comprises: determining a glabella key point and a chin key point in the face of the portrait in the original image; and determining the line connecting the two key points as the splitting line of the target object comprises: determining a line connecting the glabella key point and the chin key point as the splitting line of the portrait.

Optionally, identifying the target object in the original image to obtain the splitting line of the target object comprises: determining a detection box of the target object in the original image; and determining, based on a central axis of the detection box, the splitting line of the target object.

Optionally, replacing the pixel value of the first-side image with the preset pixel value comprises: traversing pixel points of the target object image, and inputting coordinate information of each traversed pixel point to a function of the splitting line to obtain a result value of the coordinate information of each traversed pixel point; in a case that the result value of the coordinate information of each traversed pixel point is greater than a preset value, replacing a pixel value of each traversed pixel point with the preset pixel value; or in a case that the result value of the coordinate information of each traversed pixel point is less than a preset value, replacing a pixel value of each traversed pixel point with the preset pixel value.

Optionally, replacing the pixel value of the first-side image with the preset pixel value comprises: selecting a pixel value from a background area of the original image as the preset pixel value; and replacing the pixel value of the first-side image with the preset pixel value.

Optionally, after replacing the pixel value of the first-side image with the preset pixel value, the method further comprises: blurring the first-side image including the replaced pixel value.

Optionally, performing, based on the splitting line, mirror processing on the second-side image to obtain the first-side mirror image comprises: for a pixel point of the second-side image, determining a pixel point of the first-side image symmetrical thereto with respect to the splitting line; determining a pixel value of the pixel point of the second-side image as a target pixel value of the pixel point of the first-side image; and rendering, based on the target pixel value, the first-side image to obtain the first-side mirror image.

Optionally, before performing, based on the splitting line, the mirror processing on the second-side image, the method further comprises: obtaining a screen aspect ratio; and adjusting, based on the screen aspect ratio, the splitting line; and wherein performing, based on the splitting line, the mirror processing on the second-side image, comprises: performing, based on the adjusted splitting line, the mirror processing on the second-side image.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure specified in the appended claims is not necessarily limited to the specific features or acts described above. Rather, the specific features and acts described above are disclosed as example forms of implementing the claims.

1. A method for image processing, comprising:
identifying a target object in an original image to obtain a target object image and a splitting line of the target object, wherein the target object image is split by the splitting line, with an image on one side of the splitting line referred to as a first-side image, and an image on the other side of the splitting line referred to as a second-side image;
replacing a pixel value of the first-side image with a preset pixel value; and
performing, based on the splitting line, mirror processing on the second-side image to obtain a first-side mirror image, wherein the first-side mirror image and the second-side image are mirror images of each other.

2. The method of claim 1, wherein identifying the target object in the original image to obtain the target object image comprises:
identifying the target object in the original image to obtain a mask image of the target object; and
fusing the mask image of the target object and the original image to obtain the target object image.

3. The method of claim 1, wherein identifying the target object in the original image to obtain the splitting line of the target object comprises:
determining two key points of the target object in the original image; and
determining a line connecting the two key points as the splitting line of the target object.

4. The method of claim 3, wherein the target object is a portrait comprising at least one of a face and a body; and wherein
determining the two key points of the target object in the original image comprises: determining a glabella key point and a chin key point in the face of the portrait in the original image; and
determining the line connecting the two key points as the splitting line of the target object comprises: determining a line connecting the glabella key point and the chin key point as the splitting line of the portrait.

5. The method of claim 1, wherein identifying the target object in the original image to obtain the splitting line of the target object comprises:
determining a detection box of the target object in the original image; and
determining, based on a central axis of the detection box, the splitting line of the target object.

6. The method of claim 1, wherein replacing the pixel value of the first-side image with the preset pixel value comprises:
traversing pixel points of the target object image, and inputting coordinate information of each traversed pixel point to an equation of the splitting line to obtain a result value of the coordinate information of each traversed pixel point; and
in a case that the result value of the coordinate information of each traversed pixel point is greater than a preset value, replacing a pixel value of each traversed pixel point with the preset pixel value; or in a case that the result value of the coordinate information of each traversed pixel point is less than a preset value, replacing a pixel value of each traversed pixel point with the preset pixel value.

7. The method of claim 1, wherein replacing the pixel value of the first-side image with the preset pixel value comprises:
selecting a pixel value from a background area of the original image as the preset pixel value; and
replacing the pixel value of the first-side image with the preset pixel value.

8. The method of claim 1, further comprising, after replacing the pixel value of the first-side image with the preset pixel value:
blurring the first-side image including the replaced pixel value.

9. The method of claim 1, wherein performing, based on the splitting line, mirror processing on the second-side image to obtain the first-side mirror image comprises:
for a pixel point of the second-side image, determining a pixel point of the first-side image symmetrical to the pixel point of the second-side image with respect to the splitting line;
determining a pixel value of the pixel point of the second-side image as a target pixel value of the pixel point of the first-side image; and
rendering, based on the target pixel value, the first-side image to obtain the first-side mirror image.

10. The method of claim 1, further comprising, before performing, based on the splitting line, the mirror processing on the second-side image:
obtaining a screen aspect ratio; and
adjusting, based on the screen aspect ratio, the splitting line;
wherein performing, based on the splitting line, the mirror processing on the second-side image, comprises: performing, based on the adjusted splitting line, the mirror processing on the second-side image.

11. (canceled)

12. An electronic device, comprising:
at least one a processor; and
a memory configured to store at least one program;
wherein the at least one program, when executed by the at least one processor, causes the at least one processor to implement a method comprising:
identifying a target object in an original image to obtain a target object image and a splitting line of the target object, wherein the target object image is split by the splitting line, with an image on one side of the splitting line referred to as a first-side image, and an image on the other side of the splitting line referred to as a second-side image;
replacing a pixel value of the first-side image with a preset pixel value; and
performing, based on the splitting line, mirror processing on the second-side image to obtain a first-side mirror image, wherein the first-side mirror image and the second-side image are mirror images of each other.

13. A non-transitory storage medium comprising computer executable instructions which, when executed by a processor of a device, causes the device to perform a method comprising:
identifying a target object in an original image to obtain a target object image and a splitting line of the target object, wherein the target object image is split by the splitting line, with an image on one side of the splitting line referred to as a first-side image, and an image on the other side of the splitting line referred to as a second-side image;
replacing a pixel value of the first-side image with a preset pixel value; and
performing, based on the splitting line, mirror processing on the second-side image to obtain a first-side mirror image, wherein the first-side mirror image and the second-side image are mirror images of each other.

14. The electronic device of claim 12, wherein identifying the target object in the original image to obtain the target object image comprises:
identifying the target object in the original image to obtain a mask image of the target object; and
fusing the mask image of the target object and the original image to obtain the target object image.

15. The electronic device of claim 12, wherein identifying the target object in the original image to obtain the splitting line of the target object comprises:
determining two key points of the target object in the original image; and
determining a line connecting the two key points as the splitting line of the target object.

16. The electronic device of claim 15, wherein the target object is a portrait comprising at least one of a face and a body; and wherein
determining the two key points of the target object in the original image comprises: determining a glabella key point and a chin key point in the face of the portrait in the original image; and
determining the line connecting the two key points as the splitting line of the target object comprises: determining a line connecting the glabella key point and the chin key point as the splitting line of the portrait.

17. The electronic device of claim 12, wherein identifying the target object in the original image to obtain the splitting line of the target object comprises:
determining a detection box of the target object in the original image; and
determining, based on a central axis of the detection box, the splitting line of the target object.

18. The electronic device of claim 12, wherein replacing the pixel value of the first-side image with the preset pixel value comprises:
traversing pixel points of the target object image, and inputting coordinate information of each traversed pixel point to an equation of the splitting line to obtain a result value of the coordinate information of each traversed pixel point; and
in a case that the result value of the coordinate information of each traversed pixel point is greater than a preset value, replacing a pixel value of each traversed pixel point with the preset pixel value; or in a case that the result value of the coordinate information of each traversed pixel point is less than a preset value, replacing a pixel value of each traversed pixel point with the preset pixel value.

19. The electronic device of claim 12, wherein replacing the pixel value of the first-side image with the preset pixel value comprises:
selecting a pixel value from a background area of the original image as the preset pixel value; and
replacing the pixel value of the first-side image with the preset pixel value.

20. The electronic device of claim 12, the method further comprising, after replacing the pixel value of the first-side image with the preset pixel value:
blurring the first-side image including the replaced pixel value.

21. The electronic device of claim 12, wherein performing, based on the splitting line, mirror processing on the second-side image to obtain the first-side mirror image comprises:
for a pixel point of the second-side image, determining a pixel point of the first-side image symmetrical to the pixel point of the second-side image with respect to the splitting line;
determining a pixel value of the pixel point of the second-side image as a target pixel value of the pixel point of the first-side image; and
rendering, based on the target pixel value, the first-side image to obtain the first-side mirror image.
